(19) United States
(12) Patent Application Publication
(10) Pub. No.: US 2014/0016544 A1
(43) Pub. Date: Jan. 16, 2014

(54) Method to enable device mobility in ZigBee networks

(71) Applicant: Man-Chi Chan, (US)

(72) Inventor: Man-Chi Chan, (US)

(21) Appl. No.: 13/547,157

(22) Filed: Jul. 12, 2012

(51) Int. Cl. H04W 8/02

(52) U.S. Cl. 370/328

(57) ABSTRACT

A method with novel procedures to enable device mobility in ZigBee networks is invented and the method can be used in ZigBee systems for managing mobile devices under different applications, like mobile devices control system and mobile announcement system. The method solves the problems of the short address assignment and pending data buffering for the left-over devices in a ZigBee system. The present invention is dedicated to the management of mobile devices in a ZigBee system.

### FIELD OF THE INVENTION

The present invention relates generally to the method to enable mobile devices in ZigBee networks. More particularly, the invention relates to the application framework and protocol for a ZigBee device to move from its existing parent coverage to a new parent coverage, and release the network address for its old parent for address reuse.

### BACKGROUND OF THE INVENTION

Wide area network for mobile devices to communicate by short data/commands is proverbially applicable to applications such as networked device control systems and mobile announcement systems. The general requirements for such applications are simple operation, large coverage, low power and low cost. Currently, ZigBee probably is the standard to fulfill most of the requirements of the short data/command operated network. ZigBee is an established set of specifications for wide area wireless personal area networking (WPAN), and the standard provides a cost-effective, standards-based wireless networking solution that supports low data rates, low power consumption, security and reliability. The ZigBee standard well defines the physical layer, medium access control (MAC) layer, network layer and part of the application layer for devices to establish tree topology networks and communicates through mesh routing on the tree network. However, the design is targeted for non-moving devices to send small packets, hop by hop between relatively short ranges, over a large coverage network. In the case of mobile device applications, existing ZigBee networks do not provide sufficient support for devices to be carried between different coverage of routers/parents.

According to the ZigBee specification, Reduce Function Device (RFD) is the device type defined for battery powered devices to reduce the power consumption during operation. The RFD joins the network though a router and the router will be the parent of the RFD after the RFD has been successfully attached to the router. A short address, which is a unique network address, will be assigned to the RFD by the parent. The RFD is allowed to communicate with other network stations through its parent only. When a RFD has found that the connection with its parent is lost, the RFD will be unable to communicate with any other device in the network, and this RFD will either look for its parent or join another router to be its parent.

When a ZigBee network is used for a mobile application, mobile devices in the network are configured as RFD devices, in an attempt to reduce power consumption of them, and such devices may move over different routers frequently. Each time when a mobile device has found itself losing connection with its parent during the movement, it will join another router and request a new short address from the new parent. However, the old parent does not detect that the mobile device has left, and therefore the former short address assigned to the mobile device is held up. Since each router in the network has a limited set of short address for assignment, after numerous mobile devices have joined and left a router, all the short address of the router may be held, and in such circumstance, this router will not accept any other device to join since then. Another problem that a router might encounter is that when data is being transferred to its child, the corresponding router needs to buffer the data until the child wakeups and requests data from its parent. In the case that the child has left the parent coverage without any notification to the parent, the parent will keep the data in its memory and cause buffer overflow after a long period. These problems are fearfully affecting the network address assignment and it may eventually paralyze the entire network.

On the aspect of address assignment, the present invention provides a method for the router of a ZigBee system to release address of the left-over device. In the ZigBee standard, the specifications have reserved space, the application framework, in the application layer for different manufacturers to define their application objects, in which the application object contains the proprietary procedures, schedules, mechanisms, user interface, control actions, etc. The invented method is placed in such application framework as an application object/profile for managing the short address release. The present invention provides effective method for mobile devices operating in a ZigBee network.

### BRIEF SUMMARY OF THE INVENTION

The present invention is directed to the method for mobile devices to cooperate with a Zigee network. From a broad sense aspect, the present invention provides a Mobile Application Profile (MAP) for the application layer of ZigBee standards in which the MAP, containing the procedures for the RFD to inform its old parent that it is out of the coverage of the old parent, and therefore the old parent releases the assigned short address and reuses the address for the new joining device.

### BRIEF DESCRIPTION OF THE DRAWINGS

FIG. 1 is the overview of the Mobile Application Profile for ZigBee network,

FIG. 2 shows the position of the MAP in the ZigBee protocol stack,

FIG. 3 illustrates the general frame format of the MAP,

FIG. 4 is the table showing the different command type with the command parameters,

FIG. 5 illustrates the procedures of a ZMD joining the ZigBee network first time through a ZMH,

FIG. 6 illustrates the procedures of a ZMD joining another ZMH as parent after the ZMD has left the coverage of old parent,

FIG. 7 shows the procedures to remove the record of a ZMD from the database after the ZMH finds that the ZMD has been turned off or left the network coverage,

FIG. 8 shows an example when a ZMD has joined another parent but the old parent has not be notified,

FIG. 9 illustrates the application data transfer in the case that the sender is ignorant of the short address of the receiver,

FIG. 10 illustrates the application data transfer in the case that the sender does not have the updated short address of the receiver, and

FIG. 11 illustrates the application data transfer in the case that the receiver has left the network.

### DETAILED DESCRIPTION

The following detailed description of preferred embodiments refers to the accompanying drawings illustrating specific embodiments of the invention. Other embodiments having different structures and operations do not depart from the scope of the present invention.

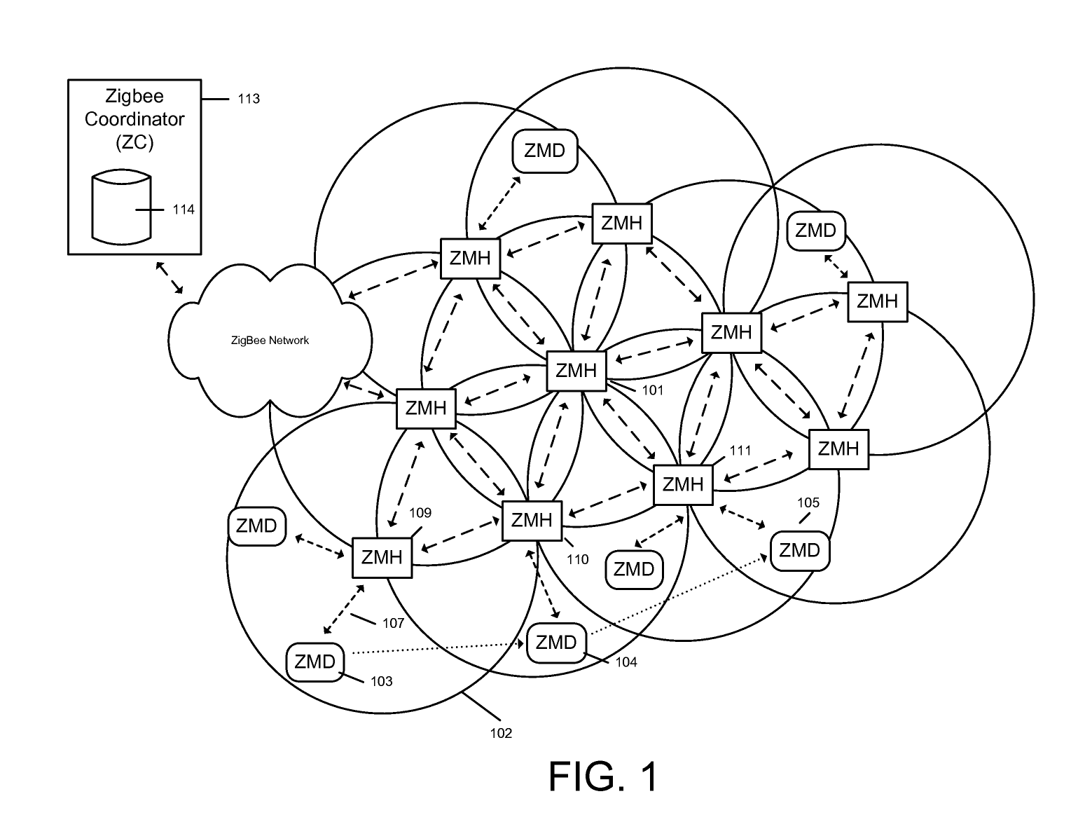

In the Mobile Application Profile (MAP) for the ZigBee system, three types of device are defined, they are ZigBee Coordinator (ZC), ZigBee Mobility Handler (ZMH) and ZigBee Mobile Device (ZMD). FIG. 1 shows the proposed system architecture for the MAP enabled ZigBee network. In the network, The ZC 113 is the unique device in the system, which is equipped with database 114 for managing the short address and the extended address mapping for the mobile devices. The ZMHs (eg. 101/109/110/111) are the ZigBee routers (Full Function Device—FFD) at the fixed location in the network to handle ZMDs (eg. 103/104/105) moving within the system coverage. The ZMDs (eg. 103/104/105) are the ZigBee End-Devices (RFD) in the network, they are expected to move frequently between different coverage of the ZMHs.

In FIG. 1, each ZMH (eg. 101/109/110/111) can connect to other ZMHs in the neighborhood directly. The communication links establishment between ZC to ZMH and ZMH to ZMH are formed by the mesh network routing. When a ZMD has joined a ZMH, the ZMD can communicate with other devices in the network through its parent.

To enable the mobility of ZMD 103/104/105 in the network, the ZMD has the self-detection ability to discover that it has already been anchored to another ZMH's coverage and lost connection with the old parent. In the MAP, two mechanisms are available to accomplish detection, namely the ZMD polling mechanism and the ZMH broadcast mechanism.

In the ZMDs polling mechanism, the ZMD uses polling provided by the

MAC layer of the ZigBee stack to detect the signal strength of ZMD. In the example shown in FIG. 1, the ZMD 103 joined a ZMH 109 as parent, the ZMD 103 sends “poll request” 107 to its parent 109 periodically with a frequency f. Each time when the parent 109 has received the polling request, the parent needs to acknowledge 107 the corresponding child to indicate the signal strength of parent to the ZMD. Therefore, when a ZMD is moving out of the coverage 102 of its old parent to a new parent (from ZMD 103 to ZMD 104), its old parent 109 may either not receive the “poll request” from the ZMD 104 or receive the “poll request” with weak signal strength. When the old parent 109 does not receive the “poll request”, ZMD 104 will not receive acknowledgment from its old parent 109. In the event that the old parent 109 has received the “poll request”, the old parent 109 will reply the ZMD with weak signal strength.

In the ZMH broadcast mechanism, the parent (ZMH) will broadcast “poll response” to all its children (ZMD) periodically to indicate the signal strength of the parent to children.

Both the ZMD polling mechanism and the ZMH broadcast mechanism are used to indicate that the ZMD is within the parent coverage. If the ZMD 104 receives weak signal strength “poll response” or fails to receive “poll response” from its parent several times within a predefined period Ts, the ZMD identifies that it is already out of coverage of its old parent and it then seeks to join a new ZMH as its parent. Since the role of ZMD in the two mechanisms is the same, the ZMD polling mechanism will be described in the following context.

When a ZMD 104 has lost connection with its old parent 109, the ZMD keeps both the short address of the old parent and the short address of itself, which is assigned by the old parent. After the ZMD 104 has joined a new ZMH 110 successfully and received a new short address, it sends a notification to its old parent 109 with its former short address to inform the old parent 109 of its absence from the coverage 102. When the old parent 109 has received the notification from the ZMD 104, it confirms that the ZMD 104 is not its child, it then releases the short address for reuse and leases the pending data of the child.

The short address of a device is a main identifier for communication in the ZigBee system, however the mobility of ZMDs (eg. 103, 104, 105) requires a frequent change of short address of a ZMD. Therefore, the database for address mapping 114 at the ZC is devised in MAP to match the addresses of ZMDs in the network. The database stores the unique extended address with the frequently updating short address of each ZMD in the network. Each time when a ZMD has joined a new ZMH and received a new short address, the ZMD will send an announcement to the ZC to update the record of the ZMD. Therefore, when a device has found that it is unable to communicate with a ZMD using its short address, the device may inquire the ZC about the updated short address of the ZMD by providing the corresponding extended address.

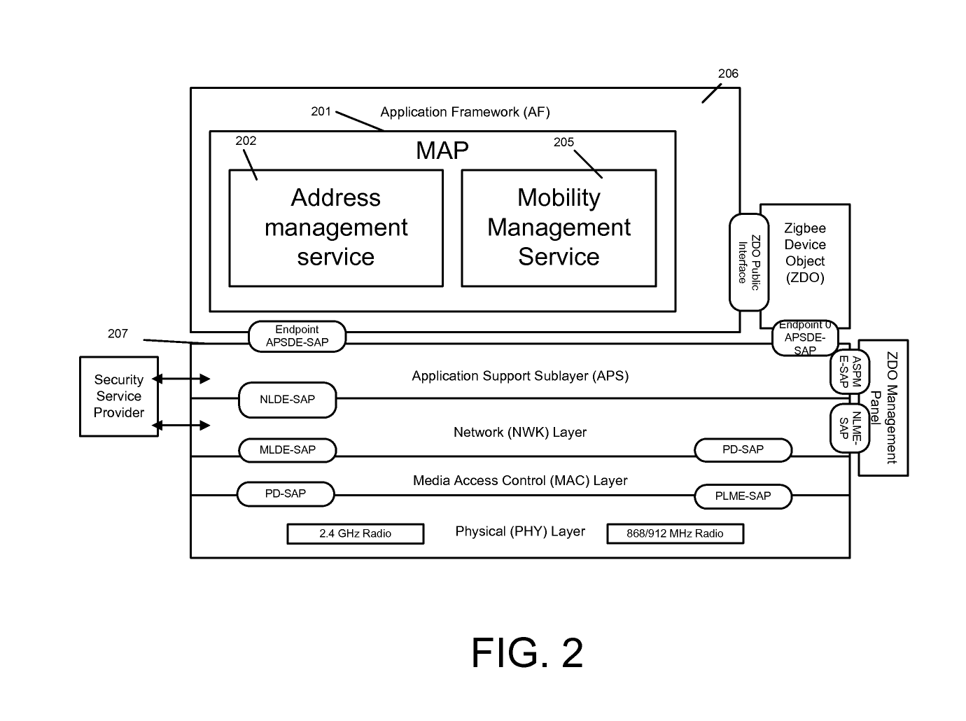

FIG. 2 shows the position of MAP in ZigBee protocol stack. According to the ZigBee specification, the application layer is divided into application support sub layer (APS) 207 and application framework (AF) 206. The AF 206 is used to house the manufacturer defined application objects (AO), which is the proprietary application protocol, for the purpose of applying ZigBee standard to different applications. The invented MAP 201 is a member of the AOs enabling device mobility in different applications. The MAP provides Address Management 202 and Mobility Management 205 service to handle the movement of ZMDs in a ZigBee network.

The Address Management Service 202 is applied to the ZC, ZMH and ZMD, and it coordinates the procedures to update the record of the address mapping database for the newly jointed or timeout ZMD. After a ZMD has joined a ZMH as its parent, the ZMD informs the ZC to update the address database with the new short address assigned to the ZMD through this service 202. The ZC will check whether the ZMD is a newly joined device or altered parent device in the network according to the provided extended address of the ZMD. If the ZMD is a newly joined device, the ZC will create a new record in the database to match the short address and the extended address of the ZMD; if the ZMD is not a newly joined device, and that the extended address appears in the record, the ZC will update the short address of the existing record of the ZMD.

On the other hand, when a ZMD has joined a ZMH as its parent, the ZMH will also start a timer to count the lifetime TL of the ZMD connection. This TL is used to make sure the short address will not be held by a ZMD in the event that the ZMD has left the network without any notification. After the TL of a ZMD is timeout and the old ZMH has not been informed that the ZMD has joined other a new ZMH, the old ZMH will assume the ZMD has been turned off or left the network coverage. The ZMH releases the short address of the ZMD, and informs the ZC to remove the record of corresponding ZMD from the database through the Address Management Service 202 by sending the short address and the extended address to the ZC. Then the ZC will check the database record to confirm that the ZMD has left or joined a new ZMH. Once the ZC has matched a record in the database to the short address and the extended address received from the ZMH, it will remove the record; if the ZC has only matched a record in the database identical with the extended address received from the ZMH, it implies that the ZMD has joined a new ZMH since the former ZMH has not received any information. The ZC will inform the former ZMH that the ZMD has moved to a new ZMH. The Mobility Management Service 205 coordinates the procedures to manage the ZMD movement and defines the parent altering procedures.

The parent altering is the procedures for the ZMD to inform the old parent that it has moved to another parent and the old parent will release the resources for the ZMD. After the ZMD has joined a new ZMH, it sends the parent altering request to the former ZMH through the service 205 to request the old parent to release the short address for reuse, and release the pending data of the ZMD.

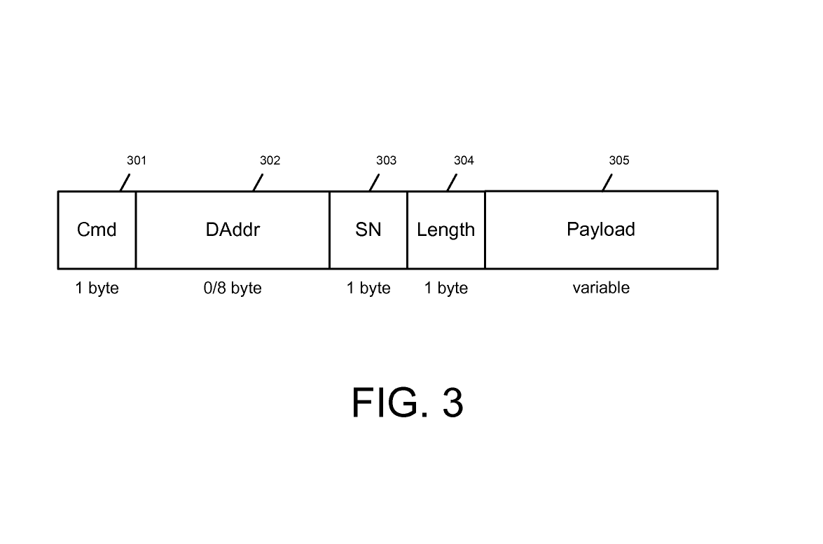

FIG. 3 shows the general frame format of MAP. The frame includes the field of Command Type (Cmd) 301, Destination Address (DAddr) 302, Sequence Number (SN) 303, Length 302 and Payload 303. The Cmd 301 is a 1-byte identifier indicating the function of the frame. The DAddr 302 only appears in the frame defined as data type and it is used to confirm the identity of the receiving device. The SN is a 1-byte sequence number value whose value will be incremented by 1 with each newly transmitted frame. The sender short address reported by the lower layer—the APS layer of ZigBee stack, and the sequence number are taken as a pair used to uniquely identify a frame within the constraints imposed by the sequence number's 1-byte range. The Length 304 is a 1-byte field to indicate the length of attached data in payload 305, and the payload 305 is used to place the application data.

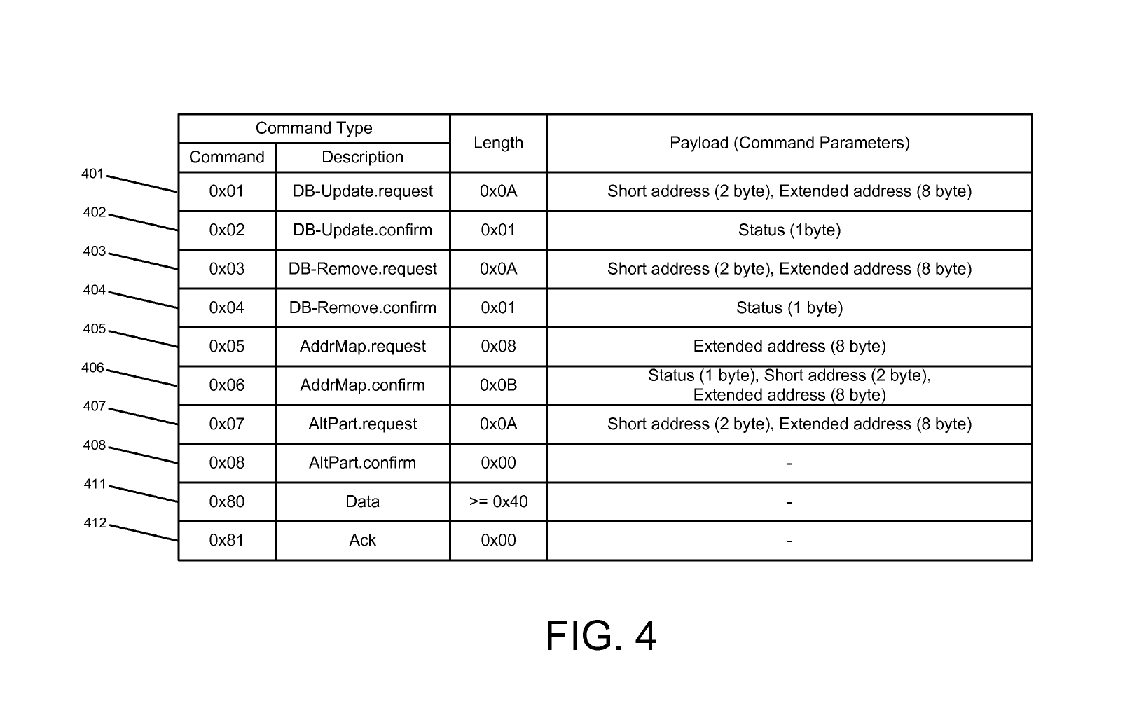

FIG. 4 shows a table describing various command types with the command parameters used in MAP. The DB-Updata.request 401 is used for a ZMD to update its record in the address mapping database at ZC, after the ZMH has accepted a ZMD to join the network. The DB-Updata.request 401 contains the short address and the extended address of the newly joined ZMD for the ZC to locate the record in the database. When the ZC has received the DB-Updata.request 401 from a ZMH, it will update the database and reply the ZMD with DB-Update.confirm 402. If the ZC has identified the ZMD as a new device in the network, the replying status of DB-Update.confirm 402 will be “added”; If the ZC has found the ZMD as an existing device in the network, the replying status of DB-Update.confirm 402 will be “success”; If the ZC cannot update the database for any reason, the replying status of DB-Update.confirm 402 will be “nonsuccess”.

The DB-Remove.request 403 is used for a ZMH to remove a certain ZMD record in the address mapping database in the ZC, after the ZMH has found that the TL of its child is timeout and the ZMH has not been informed that the ZMD has joined a new ZMH. The DB-Remove.request 403 contains the short address and the extended address of the timeout ZMD for the ZC to locate the record in the database. When the ZC has received the DB-Remove.request 403 from a ZMH, it will update the database and reply the ZMH with DB-Remove.confirm 404. If the ZC has found that both the short address and the extended address of the ZMD match the record in its data base, it will delete the record and the replying status of DB-Remove.confirm 404 will be “success”; If the ZC has found the extended address of the ZMD but the short address does not match, it implies that the ZMD has joined a new parent but the old parent has not been notified, the replying status of DB-Remove.confirm 404 will be “changed parent”; If the ZC cannot update the database for whatever reason, the replying status of DB-Remove.confirm 404 will be “nonsuccess”.

The AddrMap.request 405 is used for a device to request the updated short address of a ZMD from ZC when the device finds that it fails to be connected to the ZMD. The AddrMap.request 405 contains the extended address of the ZMD which loses connection with its parent, and such extended address is used for the ZC to locate the record in the database which records the lost connection of the ZC. When the ZC has received the AddrMap.request 405 from a ZMH, it will find the short address of the ZMD from the database and reply the device with AddrMap.confirm 406. When the record is found, the AddrMap.confirm 406 will be replied with the status of “success”, the updated short address and the extended address of the ZMD; if the record is not found, the AddrMap.confirm 406 will be replied only with the status of “nonsuccess”.

The AltPart.request 407 is used for a ZMD to inform the old parent it has joined a new parent ZMH already, and the request provides the former short address and the extended address of ZMD to the old parent as reference. When the ZMH received the AltPart.request 407, it will release the short address and remove the pending data of the previous child, then reply the former child with AltPart.confirm 408.

The Data 411 indicates that the content of the frame payload is the application data. This kind of frame is used for a device within the ZigBee network to send application layer data to another device in the network. The maximum size of the data in the payload of MAP is 64 bytes. After a device has received a frame for which the command type is Data 411, the device will reply the sender by an acknowledgment frame, and the command type is Ack 412.

The details of the MAP operation will be described in the following paragraphs with different cases.

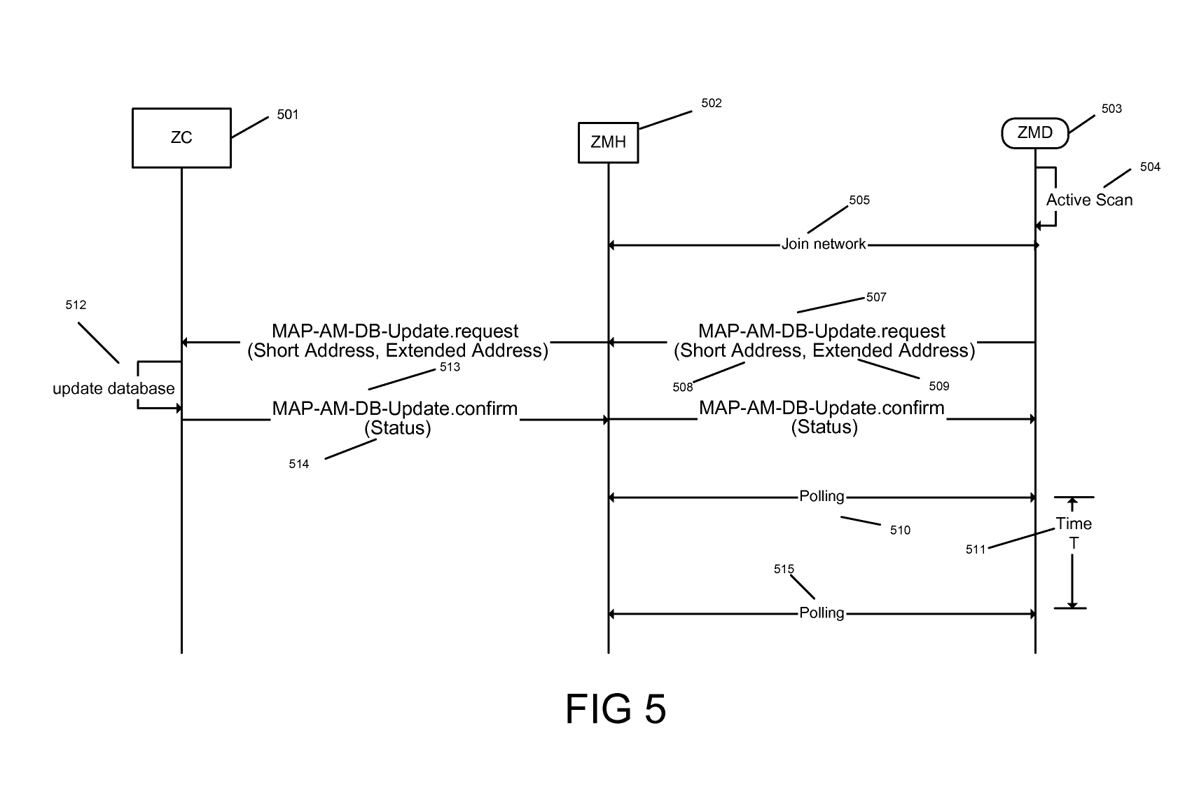

FIG. 5 illustrates the procedures of a ZMD 503 joining the network for the first time. The ZMD 503 will first initiate active scan procedure 504 to look for an available ZigBee network. After the active scan procedure 504 has been completed, it will choose ZMH 502 as its parent and go through the join network procedures 505 according to the ZigBee specification. When the ZMD 503 has joined the network successfully, the ZMD 503 will send a MAP-AM-DB-Update.request 507, with its short address 508 and extended address 509 to the ZC 501, to inform the ZC to update the databse. After the ZC has received the update request 507 forwarded by ZMH 502, it will find the record of the ZMD 503 according to the provided extended address 509. In this case, since the ZMD 503 is a newly joined device in the network, the ZC creates a new record in database for this ZMD with the provided short address 508 and extended address 509. After the database is updated, the ZC sends back a confirmation, namely the MAP-AM-DB-Update.confirm 513 with the status of “added” 514, to ZHD 503. In the event that the ZC 501 found the database is full or for any other reason causing the ZC 501 cannot update the database, the ZC will send back a confirmation, namely the MAP-AM-DB-Update.confirm 513 with the status of “nonsuccess” 514, to ZHD 502 to indicate that the record cannot be updated and thus other device in the network cannot retrieve the short address from the ZC 501 to locate the ZMD in the network.

After the ZMD 503 has joined the ZMH 502, the ZMD 503 will perform the IEEE802.15.4 MAC layer polling procedure 510/515 periodically, with a T (T=1/f) time interval 511, for requesting data from the network in indirect mode.

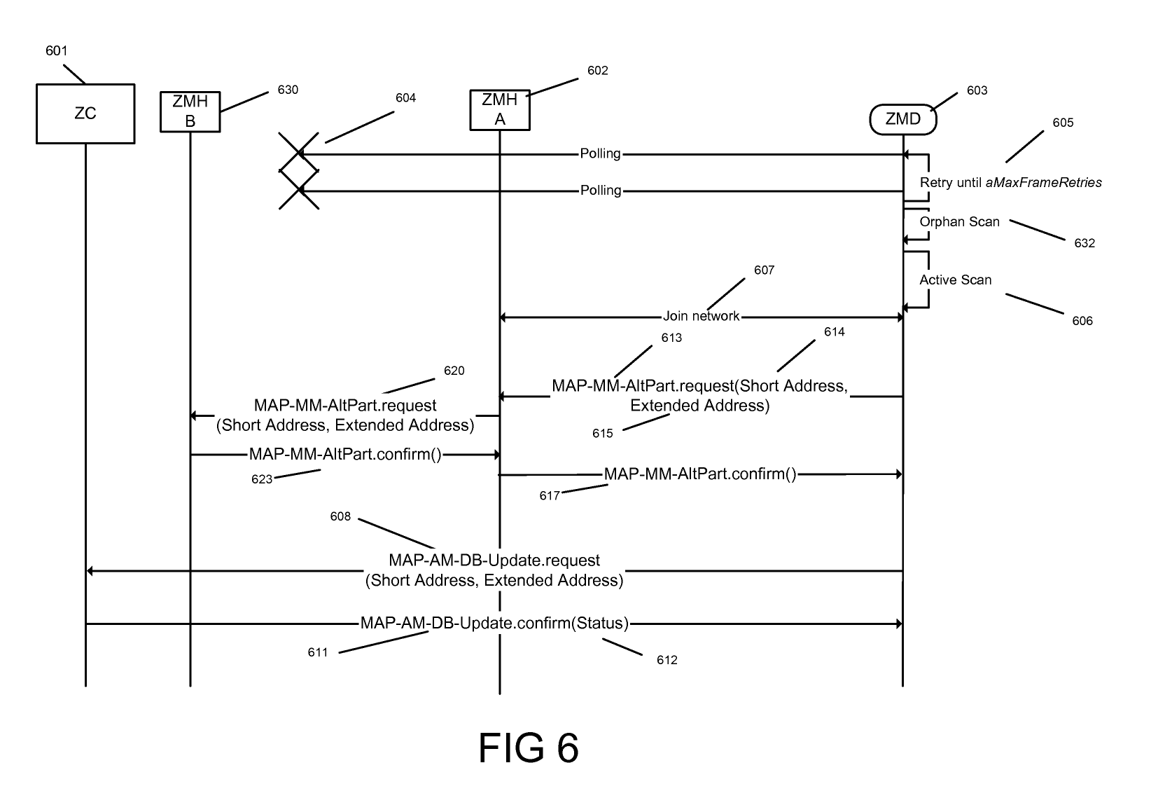

FIG. 6 shows another example of a ZMD 603 joining a new parent ZMH 602 after the ZMD 603 has left the coverage of old parent 630. When the ZMD 603 fails to poll 604 its existing parent after a time interval 605, it will start the Orphan Scan 632 from the MAC layer to find its new parent. If the parent is found, the ZMD 603 may resume the communication; however, if the parent is not found, the ZMD 603 shall start the active scan 606 to find a new ZMH to join the network. In this example, ZMH A 602 is found and the ZMD 603 joins the new parent 607 ZMH A 602.

After the ZMD 603 has joined the new parent 602 successfully, it sends a request command, MAP-MM-AltPart.request, 613 to the old parent 630 via ZMH A 602 to inform the old parent 630 it has joined a new parent. The request command 613 contains the formerly assigned short address 614 and the extended address 615 of the ZMD 603. When the old parent 630 has received the request command 620, it will release the short address and pending data of the ZMD 603, and replies with the confirmation command, MAP-MM-AltPart.confirm 623.

After the old parent is notified, the ZMD 603 sends request 608 to the ZC 601 to update the database record. In this case, since the ZMD 603 has joined the network before, the ZC 601 can retrieve the record from the database, and the confirmation 611 being sent back to the ZMH 602 is attached with the status “success” 612.

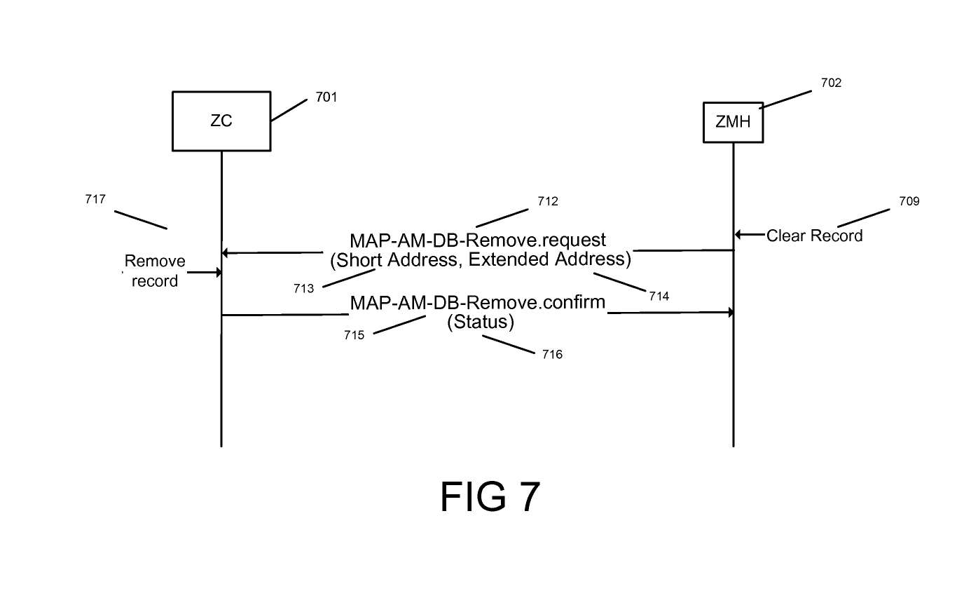

After a ZMD has joined a new parent ZMH, the parent will start a timer to count the lift time TL of the ZMD. After the TL of the ZMD is timeout and the old parent has not been informed that the ZMD has joined a new parent, the old parent assumes the child has left the network. The old parent will then release the short address and pending data of the child and ask ZC to remove the record of the child from the database. FIG. 7 shows the procedures to remove the record of a ZMD from the database when the ZMH 702 assumes that one of its children has left the network coverage. After the old parent 702 has released the short address and pending data of the child 709, the old parent sends a MAP-AM-DB-Remove.request 712 command to the ZC 701 to remove the record of the child from the database. The command 712 contains the short address 713 and the extended address 714 of the child. When the ZC 701 has received the command 712, it will find the record of the child. If both the short address 713 and the extended address 714 match with its record, the ZC will remove the record and send back a confirmation 715 to the ZMH 702 with the status “success”; If the record of the extended address is not found or for whatever reason causing the ZC not finding the record, the ZC will send back a confirmation 715 to the ZMH 702 with the status “nonsuccess”.

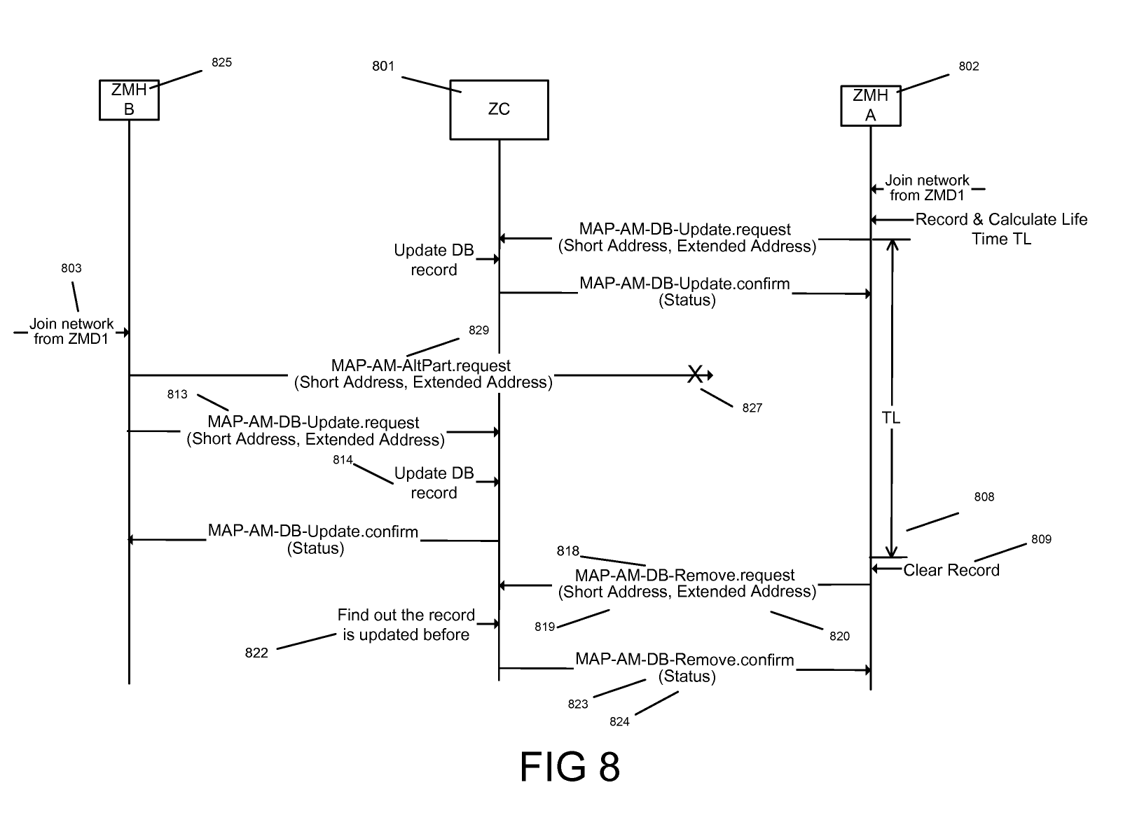

In some occasions, a ZMD has may join a new parent without the old parent being notified. In this case, the old parent will also release the assigned short address and the pending data for this ZMD after the TL of the ZMD is timeout. In the example shown in FIG. 8, the ZMH A 802 is the old parent of the ZMD1 and the ZMH B 825 is the new parent of the ZMD1. Considering the case after the ZMD1 has joined 803 the ZMH B 825, the ZMD1 is sending back the notification 829 to the old parent ZMH A 802 but the notification is lost during transmission 827. After the TL counter of the ZMD1 under the coverage of ZMH A 802 is timeout 808 and the ZMH A 802 assumes the ZMD1 has left the network. ZMH A 802 releases the short address and pending data 809 of the ZMD1 and ask ZC 801 to remove the record of the ZMD1 from database. When the ZC 801 has received the request from the ZMH A 818, it will check the database to find out the record according to the provided extended address 820. Since the record is previously updated 814 by the request 813 from ZMD1, the ZC 801 will find the provided short address 819 not matched with the database record 822. Therefore the ZC 801 sends back a confirmation 823 to the ZMH 802 with the status of “changed parent” 824.

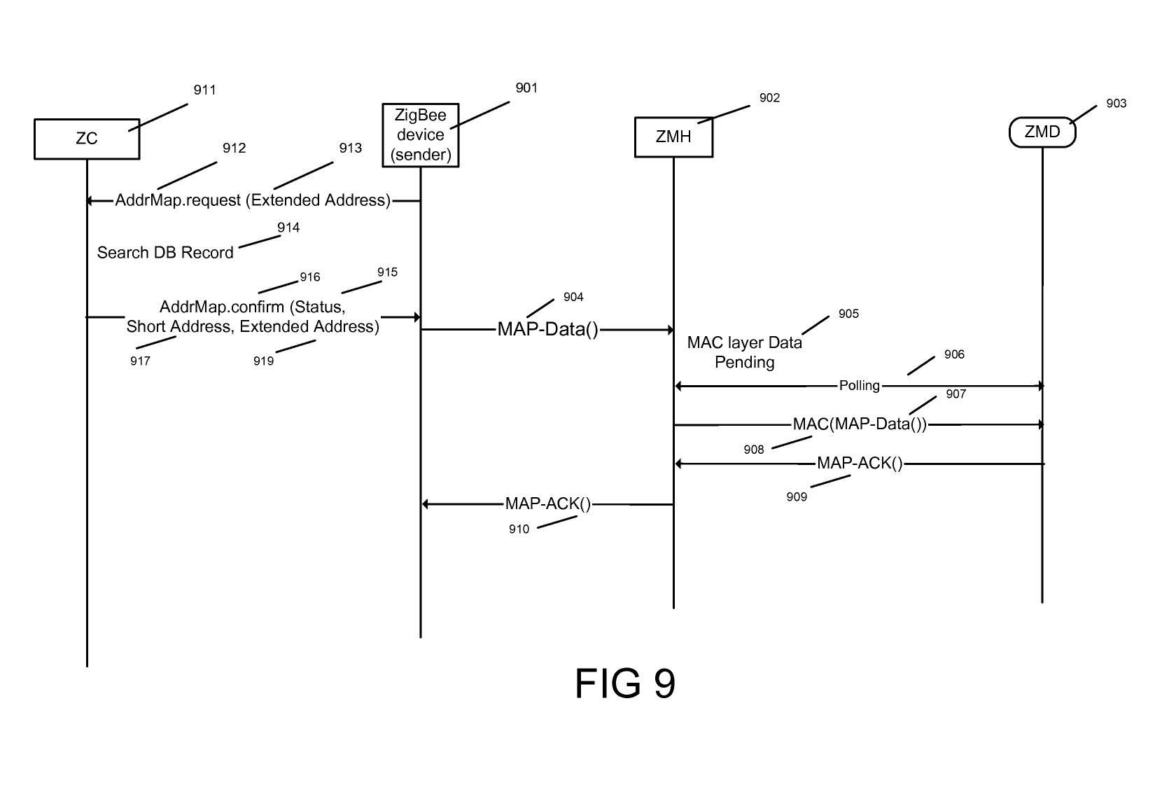

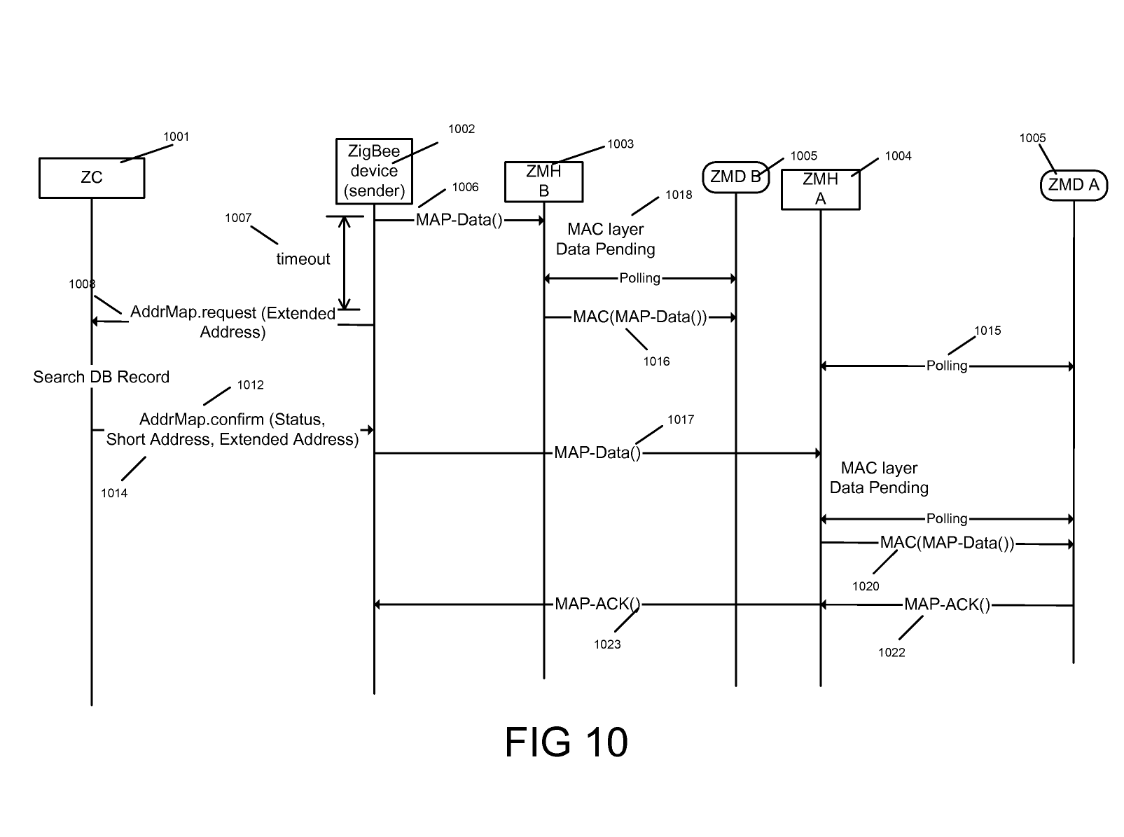

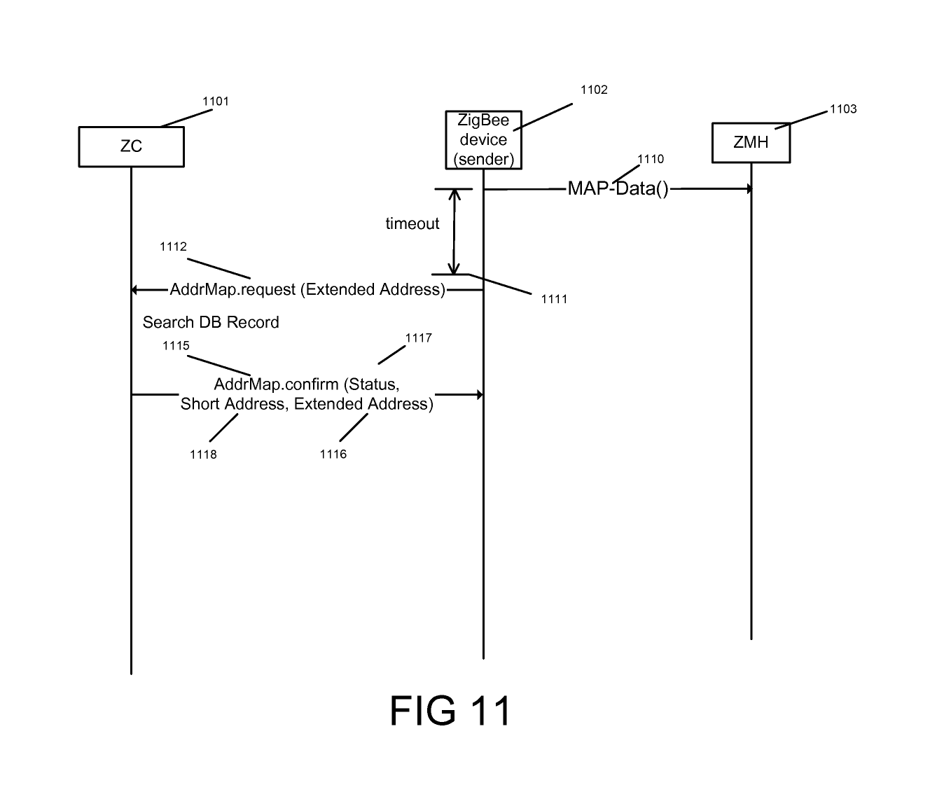

In the application data transfer of the MAP, the sender shall know the short address of the receiver before sending the data. FIG. 9, FIG. 10 and FIG.11 illustrate the different cases of application to send data from source to destination under the MAP procedures.

FIG. 9 shows a case of the sender 901 is ignorant of the short address of the receiver 903. In this case, the sender 901 shall first send a request command, AddrMap.request 912, with the extended address 913 of the receiver 903 to ZC 911 to inquire the short address of the receiver. When the ZC has accepted the command 912, it searches the database 914 to find the record of the receiver 903. Once the short address is found, the ZC 911 replies the sender with the following commands: a AddrMap.confirm 916 command, the status of “success” 915, the short address 917 and the extended address 919 of the receiver. After the sender has received the reply 916 from ZC 911, it sends the data to the parent of the receiver according to the short address 904. Then the parent will store the data in the MAC layer for data pending 905, and in the event that the receiver 903 polls the parent 902, the MAC layer 908 of the parent will send the application data to the receiver 907. After the receiver has received the data, it will send back an acknowledgement, MAP-ACK 909/910, to the sender according to the short address of the sender.

FIG. 10 shows another case of the of the application data transfer. In this case, the sender 1002 knows the short address of the receiver ZMD A 1005, and this former short address is used when the ZMD A 1005 is joining the new parent ZMH B 1003. After the ZMD A has moved out of the coverage of ZMH A 1004, the short address of the ZMD A 1005 is changed, and the sender 1002 is ignorant of this information. When the sender 1002 wants to send data to the receiver according to the former short address, the sender forwards the data to the ZMH B 1003. In this situation, if the former short address is not reused, the receiver will not be found and no device will acknowledge the sender of receiving the data; if the past short address is reused, for example it has been assigned to ZMD B 1005, the ZMD B 1005 will receive the data 1016, but the ZMD B 1005 will not acknowledge the sender since the extended address attached in the data frame does not match with itself. Hence, the sender finds no acknowledgement received, and the sender considers that the short address of receiver has been changed. The sender 1002 issues the request command 1008 to the ZC 1001 and the ZC replies 1012 with the updated short address 1014. The sender will send the data to the receiver 1017/1020 and receive the acknowledgement from the receiver 1022/1023.

FIG. 11 shows a case of the receiver has left the network in application data transfer. In this case, the sender 112 knows the short address of a ZMD, and the former short address is used when the ZMD is joining the new parent ZMH 1103. After the ZMD has left the network, the sender sends data to the ZMD 1110 and finds no acknowledgement has been received 1111. The sender inquires the ZC 1101 for the updated short address 1112. In this case, if the life time count by the parent has not timeouted, the ZC will retrieve the record from the database, and reply 1115 the sender with the status “success” 1117, and the short address 1118 and extended address 1116 of the ZMD. Then the sender may verify that the short address received is identical with the record itself, and it will assume that the ZMD has left the network. On the other hand, if the lift time count of the parent is not timeout, the ZC will not retrieve the record from the database, and it will reply 1115 the sender only with the status “nonsuccess”. Then the sender may confirm that the ZMD has left the network.

What is claimed is:

1. The method to be used for enabling mobility in a ZigBee network, as an application profile, to enable device mobility, comprising: a) the procedures to allow a ZigBee RFD child, referred to as the ZigBee Mobile Device (ZMD) in the system, to inform its former parent, referred to the ZigBee Mobility Handler (ZMH) in the system, the ZMD has joined a new ZMH as parent and the old parent will release the short address and the pending data for the ZMD; b) the procedures for ZMH and ZMD to update the database of ZigBee Coordinator (ZC) to map the short address and extended address of ZMDs in the network; and c) the procedures to locate the ZMD in a ZigBee network, referred to as the provision of extended address of the ZMD to the ZC for the retrieval of the short address of the ZMD.

2. The apparatus of claim 1, wherein the database of ZC is used to map the short address and extended address of ZMDs in the network, and the database may be updated by ZMD and ZMH within the network.

3. The apparatus of claim 1, wherein the ZMHs are the ZigBee routers at the fixed location in the network to handle ZMDs moving within the network coverage, and the ZMDs are the ZigBee Reduce Function Devices in the network where the ZMDs are expected to move frequently between various coverages of the ZMHs.

4. The methods of claim 1, wherein the ZMD will keep the short address of the old parent and the short address assigned by the new parent when the ZMD has lost connection with its old parent, and will send a notification to the old parent with its former short address to inform the old parent that it has left the coverage after the ZMD has joined a new ZMH as parent.

5. The methods of claim 4, wherein the old parent will release the short address for reuse and lease the pending data of the child, if the parent has received the notification from the left-over ZMD.

6. The methods of claim 4, wherein the ZMD is required to send an announcement to the ZC for updating the record of the ZMD after the ZMD has joined a parent.

7. The methods of claim 1, wherein the ZMH will start a timer to count the leave time of a ZMD after a ZMD has joined a new ZMH, where the ZMH shall assume the ZMD has left when the timer is timeout and it shall release the short address and the pending data of the ZMD and send a message to ZC to delete the former record of the ZMD.

8. The methods of claim 1, wherein the device in the system shall inquire the ZC for the updated short address of certain ZMD in the system by providing the extended address of the ZMD, when the device is ignorant of the short address of the ZMD.

9. The method of claim 1, wherein there are two mechanisms, namely the ZMD polling mechanism and ZMH broadcast mechanism, to indicate that the ZMD is within the coverage of its parent.

10. The mechanism of claim 9, wherein the operation of ZMD polling mechanism are: the ZMD sends “poll request” to its parent periodically and its parent will reply the ZMD with “poll response”.

11. The mechanism of claim 10, wherein the operation of ZMH broadcast mechanism is that the ZMH will broadcast “poll response” to all its children periodically.

12. The mechanism of claim 10, wherein if a ZMD receives weak signal strength “poll request” or fails to receive “poll request” from its parent several times within a predefined period Ts, the ZMD may identify that it is out of the coverage of its parent and it will join a new ZMH as parent.
